(19) United States
(12) Patent Application Publication
(10) Pub. No.: US 2024/0118815 A1
(43) Pub. Date: Apr. 11, 2024

(54) DATA STORAGE SYSTEM AND METHOD FOR CONTROLLING ACCESS TO DATA STORED IN A DATA STORAGE

(71) Applicant: GRABTAXI HOLDINGS PTE. LTD., Singapore (SG)

(72) Inventors: Arun Ravi MUTHUTHODI VARIKKOTTIL, Singapore (SG); Wenli WAN, Singapore (SG); Li Yu TAY, Singapore (SG); _ NAVDEEP, Singapore (SG); Parvathy KRISHNASWAMY, Singapore (SG)

(21) Appl. No.: 18/263,179

(22) PCT Filed: Mar. 30, 2022
(86) PCT No.: PCT/SG2022/050179

§ 371 Date: Jul. 27, 2023

(30) Foreign Application Priority Data
Apr. 27, 2021 (SG) 10202104267W

(51) Int. Cl. G06F 3/06

(52) U.S. Cl. CPC G06F 3/0622; G06F 3/0655; G06F 3/0673

(57) ABSTRACT

Aspects concern a data storage system comprising a data storage for storing data comprising a plurality of data elements, wherein each data element is associated with a data storage table, a data storage access interface configured to receive a request for an access to a data element from a data access client wherein the request comprises a identifier of the storage location of the data element and an access controller configured to determine a data storage table with which the data element is associated from the identifier of the storage location, determine whether the data access client has access rights to the determined data storage table allowing the access to the data element and grant the data access client access to the data element if the data access client has access rights to the determined data storage table allowing the access to the data element.

### TECHNICAL FIELD

Various aspects of this disclosure relate to data storage systems and methods for controlling access to data stored in a data storage.

### BACKGROUND

Whether customers are satisfied with an e-hailing service which enables customers to hail taxis using their smartphones largely depends on the quality of the e-hailing service's drivers, i.e. whether they take sensible routes, do not try to cheat the customers and are friendly. To have control over the quality of the drivers, an e-hailing server may maintain a data storage storing information a driver, such as whether the driver is whitelisted or blacklisted for the e-hailing service. Similarly, it may be desirable to whitelist or blacklist passengers, e.g. if they do not pay or misbehave. In general, data storages may be maintained storing entity (e.g. driver or passenger) states. A provider of an e-hailing service may also store other data in a data storage such as map data, payment information etc. Typically, it is desirable that access to data storages should be protected such that not every user can access every data element in the data storage, i.e. that there is a role-based access control (RBAC).

Accordingly, efficient and flexible approaches for role-based access control for data storages are desirable.

### SUMMARY

Various embodiments concern a data storage system comprising a data storage for storing data comprising a plurality of data elements, wherein each data element is associated with a data storage table, a data storage access interface configured to receive a request for an access to a data element from a data access client wherein the request comprises a identifier of the storage location of the data element and an access controller configured to determine a data storage table with which the data element is associated from the identifier of the storage location, determine whether the data access client has access rights to the determined data storage table allowing the access to the data element and grant the data access client access to the data element if the data access client has access rights to the determined data storage table allowing the access to the data element.

According to one embodiment, the identifier of the storage location is a Uniform Resource Identifier.

According to one embodiment, the access controller is configured to determine the data storage table by reverse lookup mapping from the identifier of the storage location.

According to one embodiment, the identifier of the storage location is a Uniform Resource Identifier and the access controller is configured to perform the reverse lookup mapping by means of traversal of a search tree which comprises a node for each character of the Uniform Resource Identifier and which comprises a leaf node comprising an indication of the data storage table.

According to one embodiment, the access controller is configured to reject the request for an access to the data element if the data access client does not have access rights to the determined data storage table allowing the access to the data element.

According to one embodiment, the data storage system comprises a data access interface, wherein granting and rejecting access to the data element comprises transmitting information specifying whether the data access client has access to the data element to the data access interface.

According to one embodiment, the information specifies access rights to the data element of the data access client.

According to one embodiment, the data access interface is configured to open an access stream to the data element if the access controller has granted the data access client access to the data element.

According to one embodiment, granting the data access client access to the data element comprises transmitting a temporary access token to the data access interface, wherein the data access interface is configured to open access for a data access client for which it has received a temporary access token from the access controller.

According to one embodiment, the request comprises a request for an access token and granting the data access client access to the data element comprises transmitting a temporary access token to the data access client, wherein the temporary access token includes an identification of the data access client.

According to one embodiment, the data access interface is configured to open access for a data access client for which it has received a temporary access token from the data access client.

According to one embodiment, comprising a logging system configured to log the access with the identification of the data access client included in the temporary access token.

According to one embodiment, the access to the data element is a write access or wherein the access to the data element is a read access.

According to one embodiment, the access to the data element is an access to a plurality of data elements including the data element.

According to one embodiment, the data storage is a datalake.

According to one embodiment, the data storage is a cloud data storage.

According to one embodiment, the data access client is implemented by a data processing entity operating according to a cluster computing framework.

According to one embodiment, a method for controlling access to data stored in a data storage is provided comprising receiving a request for an access to a data element from a data access client wherein the request comprises a identifier of the storage location of the data element in a data storage for storing data comprising a plurality of data elements, wherein each data element is associated with a data storage table, determining a data storage table with which the data element is associated from the identifier of the storage location, determining whether the data access client has access rights to the determined data storage table allowing the access to the data element and granting the data access client access to the data element if the data access client has access rights to the determined data storage table allowing the access to the data element.

According to one embodiment, a computer program element is provided comprising program instructions, which, when executed by one or more processors, cause the one or more processors to perform the method for controlling access to data stored in a data storage described above.

According to one embodiment, a computer-readable medium is provided comprising program instructions, which, when executed by one or more processors, cause the one or more processors to perform the method for controlling access to data stored in a data storage described above.

It should be noted that embodiments described in context of the data storage system are analogously valid for the method for controlling access to data stored in a data storage.

### BRIEF DESCRIPTION OF THE DRAWINGS

The invention will be better understood with reference to the detailed description when considered in conjunction with the non-limiting examples and the accompanying drawings, in which:

FIG. 1 shows a communication arrangement for usage of an e-hailing service including a smartphone and a server.

FIG. 2 shows a data storage system supporting RBAC (role-based access control).

FIG. 3 shows a data storage system according to an embodiment.

FIG. 4 shows a data storage system.

FIG. 5 shows a flow diagram illustrating a method for controlling access to data stored in a data storage.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

An e-hailing app, typically used on a smartphone, allows its user to hail a taxi (or also a private driver) through his or her smartphone for a trip.

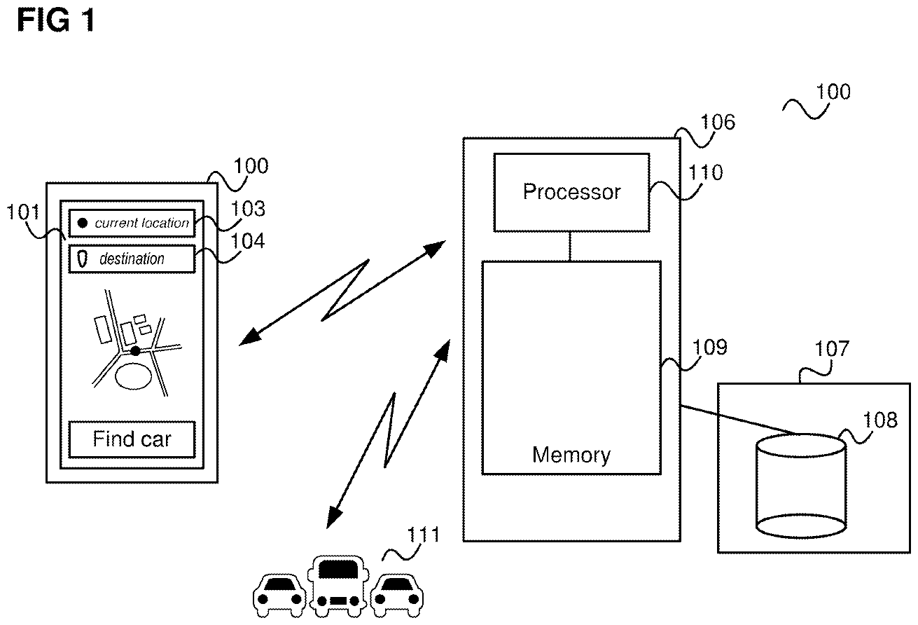

FIG. 1 shows a communication arrangement including a smartphone 100 and a server (computer) 106.

The smartphone 100 has a screen showing the graphical user interface (GUI) of an e-hailing app that the smartphone's user has previously installed on his smartphone and has opened (i.e. started) to e-hail a ride (taxi or private driver).

The GUI 101 includes a map 102 of the vicinity of the user's position (which the app may determine based on a location service, e.g. a GPS-based location service). Further, the GUI 101 includes a box for point of departure 103 (which may be set to the user's present location obtained from location service) and a box for destination 104 which the user may touch to enter a destination (e.g. opening a list of possible destinations). There may also be a menu (not shown) allowing the user to select various options, e.g. how to pay (cash, credit card, credit balance of the e-hailing service). When the user has selected a destination and made any necessary option selections, he or she may touch a “find car” button 105 to initiate searching of a suitable car.

For this, the e-hailing app communicates with the server 106 of the e-hailing service via a radio connection. The server 106 may include a data storage having information about the current location of registered vehicles 111, about when they are expected to be free, about traffic jams etc. From this, a processor 110 of the server 106 selects the most suitable vehicle (if available, i.e. if the request can be fulfilled) and provides an estimate of the time when the driver will be there to pick up the user, a price of the ride and how long it will take to get to the destination. The server communicates this back to the smartphone 100 and the smartphone 100 displays this information on the GUI 101. The user may then accept (i.e. book) by touching a corresponding button. If the user accepts, the server 106 informs the selected vehicle 111 (or, equivalently, its driver), i.e. the vehicle the server 106 has allocated for fulfilling the transport request.

It should be noted while the server 106 is described as a single server, its functionality, e.g. for providing an e-hailing service for a whole city, will in practical application typically be provided by an arrangement of multiple server computers (e.g. implementing a cloud service). Accordingly, the functionality described in the following provided by the server 106 may be understood to be provided by an arrangement of servers or server computers.

For the operator of an e-hailing service, it is of high importance that the quality of the drivers of the vehicles 111 which may be allocated to trips is high because customers will be unhappy and may stop using the e-hailing service if their driver is unfriendly, takes poor routes (e.g. taking too long) or even tries to cheat them. To be able to ensure the driver's quality, the server 106 may store information about drivers in a data storage 108, such as whether the driver is whitelisted or blacklisted for the e-hailing service. Other servers or also teams of the e-hailing provider analysing driver behaviour may then access the data storage 108 to retrieve or write data elements.

The data in the data storage being information about drivers is only an example and the data storage may store many other types of data used by servers (such as server 106) of the e-hailing system or various other data access clients of the e-hailing system. For example, it may also hold passenger information (e.g. whitelist/blacklist indications for passengers), payment information (i.e. lists of payments that were performed in context of the e-hailing service by customers), map data, driver supply information, analysis information (e.g. analysis of the demand for certain times of the day or seasons) etc.

The data storage 108 may for example be part of a cloud-based system 107 provided by a cloud storage provider. It is desirable that access to data is controlled such that not every data access client (i.e. entity acting as client for the data storage for read or write accesses or both) can access every data element in the data storage. For example, a client computer providing analysis of demand should not have write access to payment information. In other words, it is desirable that there is a role-based access control (RBAC).

One example of a framework for RBAC is Apache Ranger. However, it supports SQL validation on tables only and does not support direct access to a storage location. Other examples such as Azure Active Directory & AWS IAM (Amazon Web Services Identity & Access Management) require a high number of policies to maintain user level access and to not using dynamic row filtering and masking of data, as a user having an IAM profile has access to data and can access them using any AWS/Azure APIs (Application Programming Interfaces) directly.

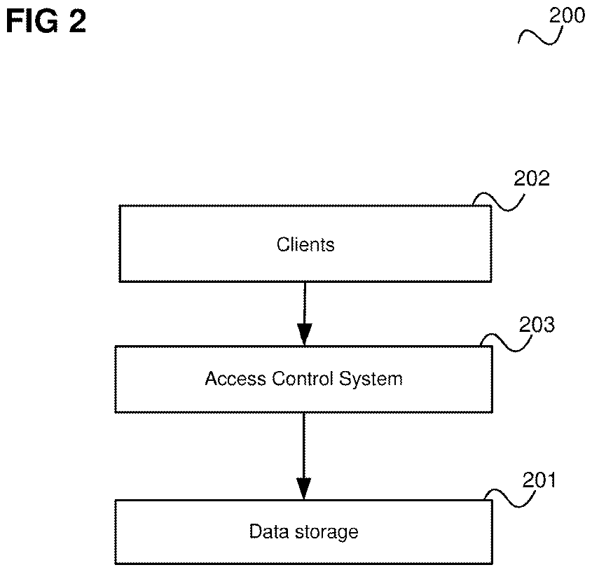

FIG. 2 shows a data storage system 200 supporting RBAC.

For controlling a data storage 201, requests by (e.g. a data lake) clients 202 to the data storage 201 are processed by an access control system 203. The clients 202 are for example data processing entities which are organized in a framework for cluster computing, such as Apache Spark, e.g. part of an analytics engine environment for large-scale data processing. The access control system 203 (at least partially implemented by an access controller, i.e. an access control server), performs client (or user) level authentication and authorization on file level. The data storage 201 is, as mentioned above, for example a cloud-based storage.

As will be described in more detail below, according to various embodiments, the access control system 203 allows achieving less dependency on cloud IAM Systems and authenticating and authorizing all forms of data access (to the data lake). It may for example be implemented to support Apache Hadoop Filesystem compliant compute frameworks such as Apache Spark and to supports various possible forms of data access avenues (e.g. SQL or File based access). It may be configured to be capable of handling rogue users who bypass SQL restrictions by using File APIs. It may be implemented to support multi-cloud and may be implemented in an existing data storage system with little changes to existing data pipelines. Furthermore, it may be configured to allow observability of accesses to the data lake 201.

According to various embodiments, a (data access) client 202 accesses the data storage 201 by means of a file or directory URI (Uniform Resource Identifier). According to various embodiments, a reverse index mechanism is used that allows identifying the associated table (or tables) for a given file/directory URI. Using this index, the access control system 203 generates temporary authentication tokens (e.g. cloud tokens) dynamically during runtime (i.e. during operation of the data storage system 200) and the clients 202 use these tokens for accessing the data storage (i.e. for showing to the data storage 201, e.g. cloud, that they have access rights). This approach may for example be implemented for the Apache Spark framework but may be implemented for other frameworks as well, in particular any computing frameworks that use Hadoop filesystem standards.

According to various embodiments, the access control system 203 ensures that no client (or user) 202 has direct access to the data storage 201 and that the data access operations to the data storage 201 are logged at the client level, thus improving security.

According to various embodiments, the access control system 203 uses a combination of in-memory lookup and temporary tokens to enforce data access control (to the data storage 201). Before exemplary embodiments are described in more detail, a few examples are given for a client 202 trying to access the data storage 201 (in an Apache Spark framework).

For example, a user (operating a client 202) knows the storage information of a certain table and is trying to access a certain partition in this table (e.g. booking codes), e.g. by a python command spark.read.parquet and indicating the path of the partition as argument of the command. It is assumed that the user does not have access rights to this table. The access control system 203, with the help of the reverse index, is able to identify the associated table and intelligently block the users access.

The same applies of the user is using an SQL based access, i.e. an SQL select query for this partition from the table.

If the user access one or more data elements (e.g. a partition) of a table to which the user has a read access right, the access control system 203 grants the request (for the read access) and the user is provided with a corresponding result.

The access control mechanism may be implemented using a client server architecture. For example, to implement it in an existing computing system according to a Hadoop abstract filesystem compliant computing framework (e.g.: Apache Spark), a client-side library is added to the class path of the framework. An access control server interacts with the backend storage of the Apache hive service and generates a reverse lookup mapping to identify the associated table for a storage location given in a request. Whenever a client 202 tries to access a table or storage location using SQL or file APIs from a computing system like an Apache Spark system, the custom file system interface opens the input or output file stream (for accessing the data storage 201), However, before opening the file stream, the custom file system interface interacts with the access control server (forwarding the file URI that the client is trying to access) and the access control server responds to the file system interface with the associated hive table name information, its root location and the client's permission for that location (i.e. whether the client can write to it or read from it).

If, for example a client 202 has READ permission on GRABPAY_AIRTIME.BILLER INFO table which is stored at location s3://grab-xxxxxxxxxxx-analytics/datalake/transformed/grappay-airtime/biller-info/ then the request is for example to

```
s3://grab-xxxxxxxxxxx-analytics/datalake/transformed/grabpay-airtime/biller-
info/year=2020/month=11/day-01/...........parquet-0000-1...parquet
and the response is
{
  “isPartOfDataLake”: true,
  “schema”: “GRABPAY_AIRTIME”,
  “tableName”: “BILLER_INFO”,
  “location”: “s3://grab-xxxxxxxxxxx-analytics/datalake/transformed/grabpay-airtime/biller-
info”,
  “permission”: “READ”,
  “error”: “”
}
```

If the client 202 has the required permission the custom filesystem interface allows opening a corresponding stream (read or write) using the underlying actual filesystem driver (e.g. from Hadoop) which is already available in the computing framework's class path. In the case that the underlying filesystem driver requires a cloud storage access token for accessing the data storage 201 the client 202 requests the access control server to provide a temporary cloud credential and passes it on to the underlying filesystem driver. According to one embodiment, each of these temporary tokens has a client name embedded in it enabling user level access logging at the storage service level (thus allowing correlation of access events if needed in the future.)

In the following, an example for an implementation of a file system interface is given in table 1.

```
TABLE 1
class GrabFileSystem extends FileSystem {
  override def initialize(name: URI, conf: Configuration): Unit = {
    //basic initialization steps
  //check-permission steps
```

| | |
|---|---|
| 1) | Using the reverse lookup index identify table associated |
| | with the URI |
| 2) | Check if the client has a minimum of READ permission |
| | on the table |
| 3) | If yes obtain a temporary token for completing the data |
| | access if no access through access denied error |
| 4) | Inject the temporary token to base fs impl and pass the |
| | uri to base fs driver and complete the operation |

```
  }
  override def open(f: Path, bufferSize: Int): FSDataInputStream = {
    // check client access right similar to initialized function
  }
  override def create(f: Path,
```

```
  permission: FsPermission,
  overwrite: Boolean,
  bufferSize: Int,
  replication: Short,
  blockSize: Long,
  progress: Progressable): FSDataOutputStream = {
```

```
    //similar to initialize but check for write access privilege
}
  // This function will return an underlying fs driver object (either from
cache or new one) based on the execution env. eg: S3AFileSystem
  def actualFSImpl( ): FileSystem = {
    // get underlying base driver implementation based on runtime and
    operating URI
  }
//Other file system operations are also authenticated using similar logic(s)
  override def close( ): Unit = { //Handle close}
}
```

To improve the performance necessary information may be cached on the access control server and the respective client to minimize the API calls to various services. According to one embodiment, to improve the performance it is ensured that all tables (e.g. hive tables) are stored within their root location itself. According to one embodiment, the access control system 203 creates a search tree based on the result of a query joining hive metastore backend's DBS, TBLS and SDS tables respectively. This can be further enhanced by including the PARTITIONS table as well, and access control may in that case be done on partition level rather than on table level.

The query may for example be an SQL Query like
select DBS.NAME as ‘schema’, TBLS.TBL_NAME as ‘table’, SDS.LOCATION as loc FROM DBS INNER JOIN TBLS ON TBLS.TBL_NAME and DBS.DB_ID=TBLS.DB_ID INNER JOIN SDS ON TBLS. SD_ID=SDS. SD_ID and SDS.LOCATION is not null

The search tree's nodes may be defined as

```
Class Node {
  children: Map[Char, Node] = new Map
  isHIveTable: Boolean
  schema: Char[ ]
  tableName: Char[ ]
}
```

The result of the SQL query allows creating the search tree which provides the mapping between URI and datalake table information.

According to one embodiment, the search tree is a prefix search tree implemented by extending a Trie data structure. Various characters in the URI form the nodes of the tree and the leaf node (aka terminal node) has additional information related to the associated table in the datalake. When a search happens the tree is traversed node by node, character by character from the input URI and when terminal node is reached, this provides the associated table information. If the terminal node does not have any associated information then it means that the URI so far is not in a registered table in the datalake. In that case instead of using table ACL (Access Control List) permission from internal IAM a file/file-prefix based ACL from the internal IAM may be used.

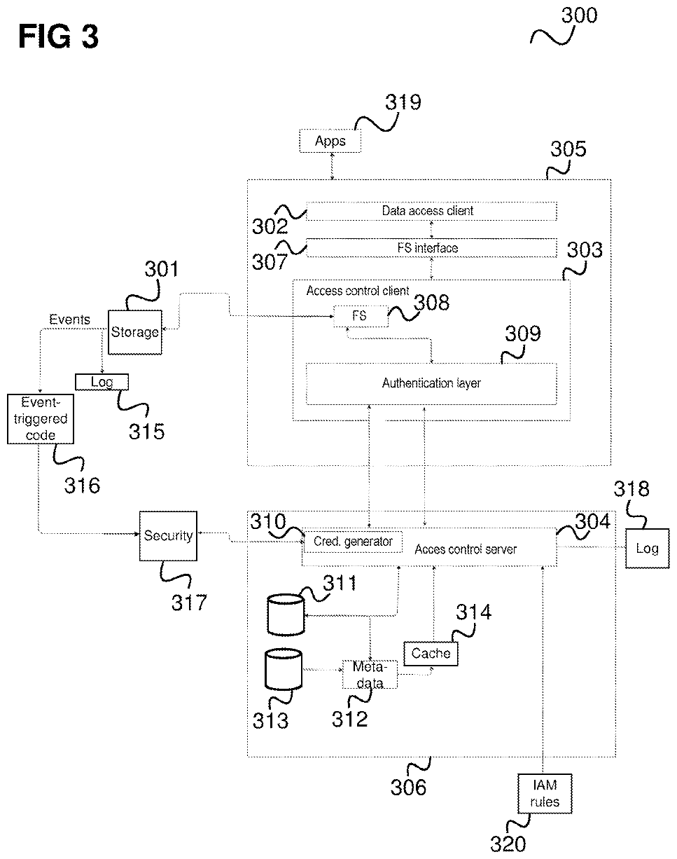

FIG. 3 shows a data storage system 300 according to an embodiment.

The data storage system comprises a data storage 301 corresponding to data storage 201 and a client 302 corresponding to one of the data access clients 202. The access control system (corresponding to access control system 203) is formed by components of various layers and entities.

Specifically, the data storage system 300 comprises an access control client 303 and an access control server 304.

The access control client 303 is for example part of a cluster computing layer component 305 (e.g. a client computer operating according to Apache Spark) and the access control server 304 is for example part of an API layer 306. For example, the data access client 302 is a computing program running on a client computer which wants to access the data storage (e.g. an application put on an Apache Spark cluster by an application source 319 (e.g. via Apache Livy). The access control client 303 is the client part of the data access system and communicates with the access control server 304.

The access control client 303 receives access requests from a file system interface 307 (e.g. Hadoop interface) as described above. A file system wrapper of the access control client 303 verifies a data access request (received from a client 302) at operation level before forwarding the request to the actual underlying files system implementation 308. An authentication layer 309 of the access control client 303 provides an access token to the file system 308 if the request is granted and otherwise outputs an error. The client's file system 308, if provided with an access token, fetches the requested data element (or data elements). It should be noted that cluster computing layer component 305 may be connected to multiple data storages 301 (e.g. cloud storages of different providers) and will access the one storing the requested data element(s). The authentication layer 309 comprises functionalities such as message deciphering and an HTTP(s) client.

The access control client 303 gets an access token (e.g. temporary cloud credentials) from the access control server 304 (e.g. on a successful 3-way handshake). For this, the access control server 304 comprises a cloud credential generator 310. The access control server 304 performs lookups, resolves resources and returns permissions on resources. For deciding whether the access request is granted, the access control server 304 may for example access a data access database 311, a metadata refresh function 312 which creates table metadata from a database replica 313, a (e.g. Redis) cache 314 and an internal IAM Rule engine. With help of these components, the access control server 304 can determine the data storage table with which the data element (or elements) to which the request requests access are associated and whether the data access client 302 has access to that table.

The authorization logic of the access control server 304 is pluggable and is in the example of FIG. 3 connected to the internal IAM system 320 but it can also be integrated with open source solutions like Apache Ranger and can fill the gap in those services as well.

The data storage (e.g. an Azure Blob Storage or Amazon S3 data storage) 301 is provided with a log 315 (e.g. an Blob Log or an S3 Cloud Watch Log) for logging data access events (for history and audit), a computing service 316 for running event triggered code (such as Azure Function or AWS Lambda) which is provided with data access events to the data storage 301 and a security service (e.g. Azure AD or AWS STS) 317 wherein the computing service 316 alerts the security service 317 when it detects an abuse. The security service 317 may communicate with the cloud credential generator.

The access control server 304 may also maintain a log (e.g. according using ELK (Elasticsearch, Logstash, Kibana)).

According to one embodiment, to perform the authentication of a client 302 the access control system may use various approaches such as a password-based authentication, an SCIM (System for Cross-domain Identity Management) API authentication or a namespace and service token authentication.

The use of temporary access (e.g. cloud) tokens (distinct for each client 302) results in the addition of a special field to the logs which allows correlating the respective access event with an external service. For example, a correlation ID may be set (and associated with the token) during temporary cloud storage access credential generation. The correlation ID is for example a client ID from the internal IAM system 320. This means that for example every REST (Representational State Transfer) API call to the data storage 301 may be logged and each of these events can be traced back to the original user or client. These service logs contain client information irrespective of how and where the client triggers a REST API call to the storage service.

The data access system 203 ensures that data storage access is authenticated, authorised and monitored. Data storage access may be democratised since request access to tables and resources may be managed by an IAM portal.

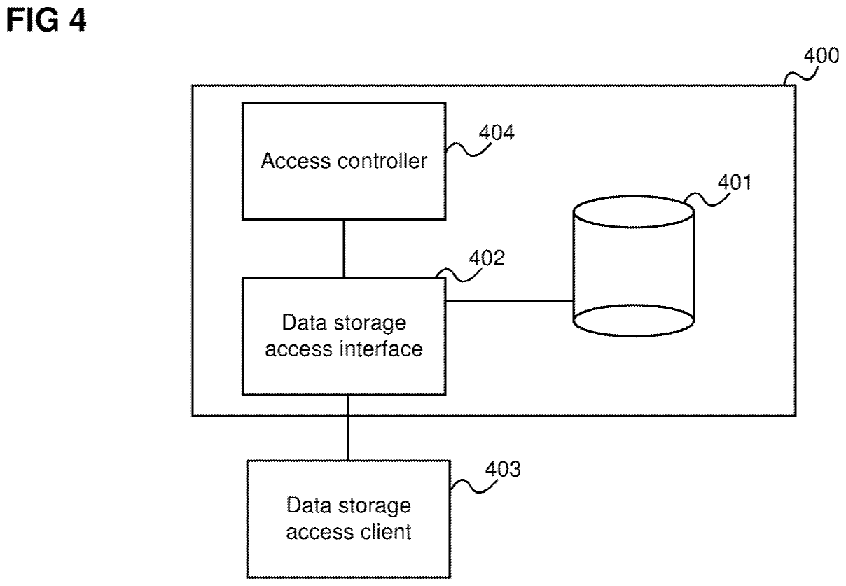

In summary, according to various embodiments, a data storage system is provided as illustrated in FIG. 4.

FIG. 4 shows a data storage system 400.

The data storage system 400 comprises a data storage 401 for storing data comprising a plurality of data elements, wherein each data element is associated with a data storage table.

The data storage system 400 further comprises a data storage access interface 402 configured to receive a request for an access to a data element from a data access client 403 wherein the request comprises an identifier of the storage location of the data element.

The data storage system 400 further comprises an access controller 404 configured to determine a data storage table with which the data element is associated from the identifier of the storage location, determine whether the data access client has access rights to the determined data storage table allowing the access to the data element and grant the data access client access to the data element if the data access client has access rights to the determined data storage table allowing the access to the data element.

According to various embodiments, in other words, when a data storage system receives a request for a certain storage location, a controlling entity determines the table to which the data element at the storage location belongs, checks the access rights of the client for the determined table and grants the right to access the storage location depending on the result.

It should be noted that a data storage table may be a sub-table (e.g. a partition) of a larger table. The data storage access interface 402 may be formed by the file system, e.g. of a client computer which comprises (e.g. runs) the data storage access client.

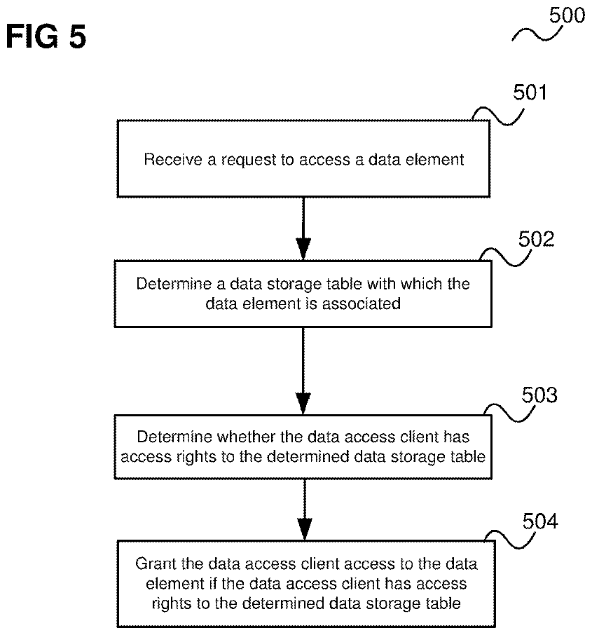

According to one embodiment, a method is provided as illustrated in FIG. 5.

FIG. 5 shows a flow diagram illustrating a method for controlling access to data stored in a data storage.

In 501, a request for an access to a data element is received from a data access client. The request comprises an identifier of the storage location of the data element in a data storage for storing data comprising a plurality of data elements, wherein each data element is associated with a data storage table.

In 502, a data storage table with which the data element is associated is determined from the identifier of the storage location.

In 503, it is determined whether the data access client has access rights to the determined data storage table allowing the access to the data element.

In 504, the data access client is granted access to the data element if the data access client has access rights to the determined data storage table allowing the access to the data element.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A data storage system comprising:
a data storage for storing data comprising a plurality of data elements, wherein each data element is associated with a data storage table;
a data storage access interface configured to receive a request for an access to a data element from a data access client wherein the request comprises an identifier of the storage location of the data element; and
an access controller configured to
determine a data storage table with which the data element is associated from the identifier of the storage location;
determine whether the data access client has access rights to the determined data storage table allowing the access to the data element; and
grant the data access client access to the data element if the data access client has access rights to the determined data storage table allowing the access to the data element.

2. The data storage system of claim 1, wherein the identifier of the storage location is a Uniform Resource Identifier.

3. The data storage system of claim 1, wherein the access controller is configured to determine the data storage table by reverse lookup mapping from the identifier of the storage location.

4. The data storage system of claim 3, wherein the identifier of the storage location is a Uniform Resource Identifier and the access controller is configured to perform the reverse lookup mapping by means of traversal of a search tree which comprises a node for each character of the Uniform Resource Identifier and which comprises a leaf node comprising an indication of the data storage table.

5. The data storage system of claim 1, wherein the access controller is configured to reject the request for an access to the data element if the data access client does not have access rights to the determined data storage table allowing the access to the data element.

6. The data storage system of claim 1, comprising a data access interface, wherein granting and rejecting access to the data element comprises transmitting information specifying whether the data access client has access to the data element to the data access interface.

7. The data storage system of claim 6, wherein the information specifies access rights to the data element of the data access client.

8. The data storage system of claim 1, wherein the data access interface is configured to open an access stream to the data element if the access controller has granted the data access client access to the data element.

9. The data storage system of claim 6, wherein granting the data access client access to the data element comprises transmitting a temporary access token to the data access interface, wherein the data access interface is configured to open access for a data access client for which it has received a temporary access token from the access controller.

10. The data storage system of claim 6, wherein the request comprises a request for an access token and granting the data access client access to the data element comprises transmitting a temporary access token to the data access client, wherein the temporary access token includes an identification of the data access client.

11. The data storage system of claim 10, wherein the data access interface is configured to open access for a data access client for which it has received a temporary access token from the data access client.

12. The data storage system of claim 9, comprising a logging system configured to log the access with the identification of the data access client included in the temporary access token.

13. The data storage system of claim 1, wherein the access to the data element is a write access or wherein the access to the data element is a read access.

14. The data storage system of claim 1, wherein the access to the data element is an access to a plurality of data elements including the data element.

15. The data storage system of claim 1, wherein the data storage is a datalake.

16. The data storage system of claim 1, wherein the data storage is a cloud data storage.

17. The data storage system of claim 1, wherein the data access client is implemented by a data processing entity operating according to a cluster computing framework.

18. Method for controlling access to data stored in a data storage comprising:
receiving a request for an access to a data element from a data access client wherein the request comprises an identifier of the storage location of the data element in a data storage for storing data comprising a plurality of data elements, wherein each data element is associated with a data storage table;
determining a data storage table with which the data element is associated from the identifier of the storage location;
determining whether the data access client has access rights to the determined data storage table allowing the access to the data element; and
granting the data access client access to the data element if the data access client has access rights to the determined data storage table allowing the access to the data element.

19. A computer program element comprising program instructions, which, when executed by one or more processors, cause the one or more processors to perform the method of claim 18.

20. A computer-readable medium comprising program instructions, which, when executed by one or more processors, cause the one or more processors to perform the method of claim 18.
